(19) United States
(12) Patent Application Publication
(10) Pub. No.: US 2016/0301961 A1
(43) Pub. Date: Oct. 13, 2016

(54) VIDEO SMOOTHING METHOD AND DEVICE

(71) Applicants: LE HOLDINGS (Beijing) CO., LTD., Chao Yang District ,Beijing (CN); LE SHI ZHI XIN ELECTRONIC TECHNOLOGY (Tianjin) LIMITED, Chao Yang District ,Beijing (CN)

(72) Inventors: Kai PING, ChaoYang District, Beijing (CN); Jiangjie TANG, ChaoYang District, Beijing (CN)

(73) Assignees: Le Holdings (Beijing Co.Ltd.; Le Shi Xin Electronic Technology (Tianjin) Limited

(21) Appl. No.: 15/100,509

(22) PCT Filed: Dec. 11, 2014
(86) PCT No.: PCT/CN2014/093599

§ 371 Date: May 31, 2016

(30) Foreign Application Priority Data
Dec. 25, 2013 (CN) 201310750815.7

(51) Int. Cl. H04N 21/242; H04N 21/8547; H04N 21/61; H04N 21/43

(52) U.S. Cl. CPC H04N 21/242; H04N 21/4305; H04N 21/8547; H04N 21/6125

(57) ABSTRACT

The present disclosure provides a method and an apparatus for smoothing videos. With the solution above according to the present disclosure, if the player starts playing, then the Vsync event detecting thread is initiated, if the Vsync event detecting thread is resumed (awoken), then whether a frame of videos to be played which satisfies a predetermined condition is stored in the first queue is detected (checked) according to the timestamps corresponding to the frames of videos to be played in the first queue, and if the frame of videos to be played which satisfies the predetermined condition is detected, then the frame of videos to be played is rendered, which can which can reduce the jitter phenomena of videos in the process of playing the videos.

### CROSS-REFERENCE TO RELATED APPLICATIONS

This application is based upon and claims priority to Chinese Patent Application NO. 20130750815.7, titled “a method and an apparatus for smoothing videos”, filed Dec. 25, 2013, the entire contents of which are incorporated herein by reference.

### FIELD OF TECHNOLOGY

The present disclosure relates to a field of computer technology, and particularly to a method and an apparatus for smoothing videos.

### BACKGROUND

Generally videos need to be played by firstly obtaining frames of videos to be played, from a video player, then surface-rendering the frames of videos to be played, and finally outputting the frames of videos.

However the play precision of the video player in the existing Android system is low, that is, there is generally an error of at least ±10 ms between a timing when a frame of videos to be played is obtained from the video player and a timestamp of the frame of videos to be played. For example, the frame of videos to be played with the timestamp of 30 ms is obtained at the timing of 20 ms.

The timings when frames of videos to be played are obtained from the video player may vary due to the above error, and the obtained frames of videos to be played are surface-rendered in the Android system at a fixed rate. Accordingly when the frames of videos to be played are surface-rendered with reference to the timings when the frames of videos to be played are obtained, then some frames of videos may be discarded, and some frames of videos may be played for a prolonged period of time, thereby resulting in serious jitter of the videos.

### SUMMARY

Embodiments of the present disclosure are to provide a method and an apparatus for smoothing videos with an object of alleviating jitter of videos to be played.

In order to attain the object above, there are the following technical solutions provided by the embodiments of the invention.

In a first aspect, there is provided a method for smoothing videos, the method including:

receiving a first indication message which indicates that a video player starts playing;

initiating a frame synchronization (Vertical Synchronization (Vsync)) event detecting thread in response to the first indication message, wherein the Vsync event detecting thread is configured, upon being resumed, to detect whether a frame of video to be played which satisfies a predetermined condition is stored;

obtaining an N-th frame of videos to be played, and storing it in a first queue created in advance, wherein the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played;

determining whether the Vsync event detecting thread is to be resumed;

detecting, if it is determined that the Vsync event detecting thread is to be resumed, whether the frame of videos to be played which satisfies the predetermined condition is stored in the first queue, according to the timestamps corresponding to the frames of videos to be played in the first queue; and

rendering, if the frame of videos to be played which satisfies the predetermined condition is stored in the first queue, the frame of videos to be played which satisfies the predetermined condition.

In a first possible implementation of the first aspect, in connection with the first aspect, the determining whether the Vsync event detecting thread is to be resumed may include:

determining whether a Vsync signal generated periodically within surface render periods is received; and

determining, if the Vsync signal is received, that the Vsync event detecting thread is to be resumed.

In a second possible implementation of the first aspect, in connection with the first aspect or the first possible implementation of the first aspect,

a condition that the timestamps carried in the frames of videos to be played satisfy a first relationship, wherein the first relationship is as follow:

t1-a≦PTS<t1±(T−a),

where t1 represents a current clock time of the Vsync event detecting thread, a represents a predetermined clock offset, PTS represents a timestamp carried by a frame of videos to be played, and T represents the surface render period.

In a third possible implementation of the first aspect, in connection with the second possible implementation of the first aspect, the predetermined clock offset in the first relationship satisfies a second condition, wherein the second condition is as follow:

0≦a<T.

In a fourth possible implementation of the first aspect, in connection with the third possible implementation of the first aspect, the predetermined clock offset may include:

a=½T, wherein the first relationship is as follow:

t1−½T≦PTS<t1+½T.

In a second aspect, there is provided an apparatus for smoothing videos, the apparatus including:

one or more processors; and

a memory;

wherein one or more programs are stored in the memory, and when executed by the one or more processors, the one or more programs cause the one or more processors to:

receive a first indication message which indicates that a video player starts playing;

initiate a frame synchronization (Vertical Synchronization (Vsync)) event detecting thread in response to the first indication message, wherein the Vsync event detecting thread is configured, upon being resumed, to detect whether a frame of videos to be played which satisfies a predetermined condition is stored;

obtain an N-th frame of videos to be played, and storing it in a first queue created in advance, wherein the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played;

determine whether the Vsync event detecting thread is to be resumed;

detect, if it is determined that the Vsync event detecting thread is to be resumed, whether the frame of videos to be played which satisfies the predetermined condition is stored in the first queue, according to the timestamps corresponding to the frames of videos to be played in the first queue; and

render, if there is the frame of videos to be played which satisfies the predetermined condition is stored in the first queue, the frame of videos to be played which satisfies the predetermined condition.

In a first possible implementation of the second aspect, in connection with the second aspect, wherein the one or more processors are configured to:

determine whether a Vsync signal generated periodically within surface render periods is received; and

determine, if the Vsync signal is received, that the Vsync event detecting thread is to be resumed.

In a second possible implementation of the second aspect, in connection with the second aspect or the first possible implementation of the second aspect, wherein the predetermined condition includes:

a condition that the timestamps carried in the frames of videos to be played satisfy a first relationship, wherein the first relationship is as follow:

t1−a≦PTS<t1+(T−a),

where t1 represents a current clock time of the Vsync event detecting thread, a represents a predetermined clock offset, PTS represents a timestamp carried by a frame of videos to be played, and T represents the surface render period.

In a third possible implementation of the second aspect, in connection with the second possible implementation of the second aspect, the predetermined clock offset in the first relationship satisfies a second condition, wherein the second condition is as follow:

0≦a<T.

In a fourth possible implementation of the second aspect, in connection with the third possible implementation of the second aspect, wherein the predetermined clock offset may include:

a=½T,

wherein the first relationship is as follow:

t1−½T≦PTS<t1+½T.

In a third aspect, there is provided a computer readable recording medium, on which programs for performing a method for smoothing videos are recorded, wherein the method comprising:

receiving a first indication message which indicates that a video player starts playing;

initiating a frame synchronization (Vertical Synchronization (Vsync)) event detecting thread in response to the first indication message, wherein the Vsync event detecting thread is configured, upon being resumed, to detect whether a frame of videos to be played which satisfies a predetermined condition is stored;

obtaining an N-th frame of videos to be played, and storing it in a first queue created in advance, wherein the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played;

determining whether the Vsync event detecting thread is to be resumed;

detecting, if it is determined that the Vsync event detecting thread is to be resumed, whether the frame of videos to be played which satisfies the predetermined condition is stored in the first queue, according to the timestamps corresponding to the frames of videos to be played in the first queue; and

rendering, if there is the frame of videos to be played which satisfies the predetermined condition is stored in the first queue, the frame of videos to be played which satisfies the predetermined condition.

In a fourth aspect, there is provided a receiving module configured to receive a first indication message which indicates that a video player starts playing;

an initiating module configured to initiate a Vertical Synchronization (Vsync) event detecting thread in response to the first indication message received by the receiving module, wherein the event detecting thread is configured, upon being resumed, to detect whether a frame of videos to be played which satisfies a predetermined condition is stored;

an obtaining module configured to obtain an N-th frame of video to be played;

a storing module configured to store the N-th frame of videos to be played which is obtained by the obtaining module in a first queue created in advance, wherein the N-th frame of videos to be played carries a corresponding timestamp;

a clock synchronizing module configured to synchronize a clock time of the Vsync event detecting thread with a first timestamp when the obtaining module obtains the first frame of videos to be played, where N≧1 and N is an integer, and the first timestamp is a timestamp corresponding to the first frame of videos to be played;

a determining module configured to determine whether the Vsync event detecting thread is to be resumed;

a detecting module configured, if the determining module determines that the Vsync event detecting thread is to be resumed, to detect whether the frame of videos to be played which satisfies the predetermined condition is stored in the first queue, according to the timestamps corresponding to the frames of videos to be played which are stored by the storing module in the first queue; and

a rendering module configured, if the detecting module detects the frame of videos to be played which satisfies the predetermined condition is stored by the storing module in the first queue, to render the frame of videos to be played which satisfies the predetermined condition.

In a first possible implementation of the fourth aspect, in connection with the fourth aspect, the determining module may be configured:

to determine whether a Vsync signal generated periodically within surface render periods is received; and

to determine, if the Vsync signal is received, that the Vsync event detecting thread is to be resumed.

In a second possible implementation of the fourth aspect, in connection with the fourth aspect or the first possible implementation of the fourth aspect, the predetermined condition may include:

a condition that the timestamps carried in the frames of videos to be played satisfy a first relationship, wherein the first relationship is as follow:

t1−a≦PTS<t1+(T−a),

where t1 represents a current clock time of the Vsync event detecting thread, a represents a predetermined clock offset. PTS represents a timestamp carried by a frame of videos to be played, and T represents the surface render period.

In a third possible implementation of the fourth aspect, in connection with the second possible implementation of the fourth aspect, the predetermined clock offset in the first relationship satisfies a second condition, wherein the second condition is as follow:

0≦a<T.

In a fourth possible implementation of the fourth aspect, in connection with the third possible implementation of the fourth aspect, the predetermined clock offset may include:

a=½T, wherein the first relationship is as follow:

t1−½T≦PTS<t1+½T.

The embodiments of the present disclosure provides a method and an apparatus for smoothing videos. The apparatus for smoothing videos receives a first indication message, and initiates a Vsync event detecting thread in response to the first indication message, where the Vsync event detecting thread is configured, upon being resumed, to detect whether a frame of videos to be played which satisfies a predetermined condition is stored; the apparatus obtains an N-th frame of videos to be played, and stores it in a first queue created in advance, where the N-th frame of videos to be played carries a corresponding timestamp, and the apparatus synchronizes a clock time of the Vsync event detecting thread with a first timestamp when the first frame of videos to be played is obtained, where N≧1 and N is a positive, and the first timestamp is a timestamp corresponding to the first frame of videos to be played; and the apparatus determines whether the Vsync event detecting thread is to be resumed, and if it is determined that the Vsync event detecting thread is to be resumed, then the apparatus detects whether the frame of videos to be played which satisfies the predetermined condition is stored in the first queue, according to the timestamps corresponding to the frames of videos to be played, in the first queue, and if the frame of videos to be played which satisfies the predetermined condition is stored in the first queue, then the apparatus renders the frame of videos to be played which satisfies the predetermined condition. With the solution above according to the embodiments of the present disclosure, if the player starts playing, then the Vsync event detecting thread is initiated, if the Vsync event detecting thread is resumed (awoken), then whether a frame of videos to be played which satisfies a predetermined condition is stored in the first queue is detected (checked) according to the timestamps corresponding to the frames of videos to be played in the first queue, and if the frame of videos to be played which satisfies the predetermined condition is detected, then the frame of videos to be played is rendered; and since periodicity of the timestamps corresponding to the frames of videos to be played is uniform, the frame of videos to be played which satisfies the predetermined condition can be selected with reference to the timestamps of the frames of videos to be played, and be rendered so that the frames of videos to be played can be rendered at a uniform rate, thereby alleviating jitter of the videos to be played.

### BRIEF DESCRIPTION OF THE DRAWINGS

FIG. 1 is a schematic flow chart of a method for smoothing videos according to a first embodiment of the present disclosure;

FIG. 2 is a schematic flow chart of a method for smoothing videos according to a second embodiment of the present disclosure; and

FIG. 3 is a schematic structural diagram of an apparatus for smoothing videos according to a third embodiment of the present disclosure.

### DESCRIPTION OF THE EMBODIMENTS

A method and an apparatus for smoothing videos according to embodiments of the present disclosure will be described below in details with reference to the drawings.

### First Embodiment

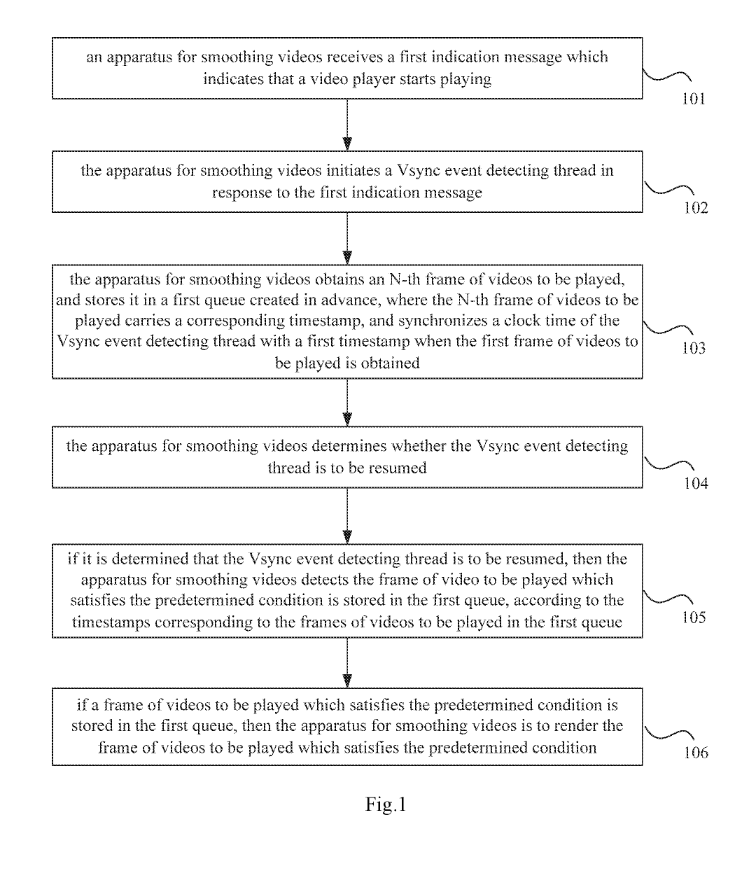

As illustrated in FIG. 1 in particular, a method for smoothing videos according to an embodiment of the present disclosure includes:

Step101, an apparatus for smoothing videos receives a first indication message which indicates that a video player starts playing.

Particularly if a user plays the video, then the apparatus for smoothing videos will firstly receive the first indication message generated as a result of the user triggering the video player, where the first indication message indicates that the video player starts playing.

It shall be noted that the apparatus for smoothing videos in the embodiment of the present disclosure may particularly be a separate apparatus installed in an Android video playing device, or may be an apparatus integrated in the Android video playing device, and the embodiments of the present disclosure will not be limited thereto, although the apparatus for smoothing videos receives the first indication message which indicates that the video player starts playing.

Step102, the apparatus for smoothing videos initiates a frame synchronization (Vertical Synchronization (Vsync)) event detecting thread in response to the first indication message.

Here the Vsync event detecting thread is configured, upon being resumed (awoken), to detect whether a frame of videos to be played which satisfies a predetermined condition is stored.

Particularly the apparatus for smoothing videos initiates the Vsync event detecting thread in response to the first indication message upon reception of the first indication message.

It shall be noted that the Vsync event detecting thread is configured to detect a Vsync signal generated by the system periodically within surface render periods, and if there is no Vsync signal arriving, then the Vsync event detecting thread will be suspended; or if there is a Vsync signal arriving, then the Vsync event detecting thread will be resumed once and further detect whether appropriate data of a frame of videos to be played are stored, and if there are such data, then the data of the frame of videos will be surface-rendered.

It shall be noted that Vsync in the embodiment of the present disclosure may be synchronization of a video frame or synchronization of another frame to be rendered, so the resumed Vsync event detecting thread will detect not only synchronization information of the video frames, but also synchronization information of the other frames to be rendered. And the embodiment of the present disclosure will not be limited thereto, but the videos will be smoothed as described in the embodiment of the present disclosure, so only the synchronization information of the video frames will be described in the embodiment of the present disclosure, while the Vsync event detecting thread will not handle the other frames to be rendered in the embodiment of the present disclosure.

Step103, the apparatus for smoothing videos obtains an N-th frame of videos to be played, and stores it in a first queue created in advance, where the N-th frame of videos to be played carries a corresponding timestamp, and synchronizes a clock time of the Vsync event detecting thread with a first timestamp when the first frame of videos to be played is obtained.

Here N≧1 and N is an integer, and the first timestamp is a timestamp corresponding to the first frame of videos to be played.

Particularly while the videos are being played, the apparatus for smoothing videos obtains the N-th frame of videos to be played, and stores the N-th frame of videos to be played in the first queue created in advance, where the N-th frame of videos to be played carries the corresponding timestamp.

Here the clock time of the Vsync event detecting thread will be synchronized with the timestamp corresponding to the first frame of videos to be played when the first frame of videos to be played is obtained, that is, if the timestamp of the first frame of videos to be played is 25 ms, then the clock time of the Vsync event detecting threshold is synchronized to 25 ms when the first frame of videos to be played is obtained, thereby ensuring timestamps of all the frames of videos to be played which are started with the first frame of videos to be played to lie in a detection period of time of the Vsync event detecting thread.

Step104, the apparatus for smoothing videos determines whether the Vsync event detecting thread is to be resumed.

Particularly the apparatus for smoothing videos may determine whether the Vsync event detecting thread is to be resumed, as follows:

It is determined whether a Vsync signal generated periodically within surface render periods is received; and

If the Vsync signal is received, then it is determined that the Vsync event detecting thread is to be resumed.

By way of an example, the surface render frequency is typically 60 Hz, that is, the render period is 16 ms, so a Vsync signal will be generated by the system at an interval of 16 ms, and be sent to the apparatus for smoothing videos, and the apparatus for smoothing videos can determine that the Vsync event detecting thread is to be resumed, and further perform the following respective steps, upon reception of the Vsync signal; and of course, if there is no Vsync signal arriving, then the Vsync event detecting thread will be suspended, so the following respective steps will temporality not be performed.

Step105, if it is determined that the Vsync event detecting thread is to be resumed, then the apparatus for smoothing videos detects the frame of video to be played which satisfies the predetermined condition is stored in the first queue, according to the timestamps corresponding to the frames of videos to be played in the first queue.

Particularly if it is determined that the Vsync event detecting thread is to be resumed, then the apparatus for smoothing videos detects the frame of videos to be played which satisfies the predetermined condition is stored in the first queue, according to the timestamps corresponding to the frames of videos to be played in the first queue, where the predetermined condition may particularly include:

The timestamps carried in the frames of videos to be played satisfy a first relationship, and the first relationship may be as follow:

t1−a≦PTS<t1+(T−a),

Where t1 represents a current clock time of the Vsync event detecting thread, a represents a predetermined clock offset, PTS represents a timestamp carried by a frame of videos to be played in the first queue, and T represents the surface render period, i.e., a Vsync period.

It shall be noted that the predetermined clock offset in the embodiment of the present disclosure is a predetermined reference variable to reflect a whole offset of a timestamp of a frame of videos to be played which are to be surface-rendered, relative to a surface render time. The whole offset may be a reference variable less than T, or may be a reference variable no less than T, and the embodiment of the present disclosure will not be limited thereto.

Preferably the predetermined clock offset in the first relationship satisfies a second condition, which may be 0≦a<T.

It shall be noted that in order to ensure that the frame of videos to be played is rendered at a time closer to the timestamp thereof, the predetermined clock offset in the first relationship is defined as less than the surface render period, so that jitter of the videos can be further alleviated.

Preferably the value of a is ½T, so the first relationship is t1−½T≦PTS<t1+½T, and at this time, the frame of videos to be played can be ensured to be rendered at the closest time to the timestamp thereof, so that jitter of the videos can be still further alleviated.

It shall be noted that since the periods of the timestamps of the frames of videos to be played are typically more than the surface render period, whether a frame of video to be played which satisfies the predetermined condition is stored in the first queue is detected with reference to the timestamps of the frames of videos to be played, then such an instance will not occur that there are two frames of videos to be played which both satisfy the predetermined condition. And if there is an error of at least ±10 ms between the acquisition time and the timestamps of the frames of videos, then more than one frame of videos will be stored in a display buffer for subsequent surface rendering, but only one of the frames can be rendered, and the other frames of videos will be discarded, thereby alleviating jitter of the videos.

Step106, if a frame of videos to be played which satisfies the predetermined condition is stored in the first queue, then the apparatus for smoothing videos is to render the frame of videos to be played which satisfies the predetermined condition.

Particularly if a frame of videos to be played which satisfies the predetermined condition is stored in the first queue, then the apparatus for smoothing videos will render the frame of videos to be played which satisfies the predetermined condition.

By way of an example, if the predetermined condition is that a timestamp carried in a frame of videos in the first queue satisfies the relationship t1−½T≦PTS<t1+½T, the surface render period is 16 m, and the period of the timestamp of the frame of videos is 25 ms, then several frames of videos to be played from obtaining of the first frame of videos to be played until synchronization of the clock time of the Vsync event detecting thread with the first timestamp will be rendered as listed below in Table 1.

TABLE 1

| Clock time (ms) of Vsync | Timestamp (ms) of frame |
|---|---|
| event detecting thread | of videos to be played |
| 32 | 25 |
| 48 | 50 |
| 64 | — |
| 80 | 75 |
| 96 | 100 |
| 112 | — |
| 128 | 125 |
| 144 | 150 |
| 160 | — |
| 176 | 175 |
| 192 | — |
| 208 | 200 |
| 224 | 225 |
| 240 | — |
| 256 | 250 |

It shall be noted that if no frame of videos to be played which satisfies the predetermined condition is stored in the first queue, then at this time the apparatus for smoothing videos will not render any frame of videos, as depicted by a sign “ - - - ” in Table 1.

With the solution in the prior art, the following instances will occur:

A frame of videos to be played, with a timestamp of 25 ms is acquired at the time of 15 ms and rendered at the time of 16 ms; and

A frame of video to be played, with a timestamp of 50 ms is acquired at the time of 58 ms and rendered at the time of 64 ms;

Here there is such a large interval of time between the time when the frame of videos to be played, with the timestamp of 25 ms is rendered, and the time when the frame of videos to be played, with the timestamp of 50 ms is rendered, such that the frame of videos to be played, with the timestamp of 25 ms may be played for a prolonged period of time.

If there is such an instance that:

A frame of video to be played, with a timestamp of 25 ms is acquired at the time of 35 ms, a frame of video to be played, with a timestamp of 50 ms is acquired at the time of 45 ms, then there will be two frames of videos to be played at the surface render time of 48 ms, and at this time one of the frames of videos will be discarded.

Thus in the solution according to the prior art, the rate at which the frames of videos are acquired is not uniform, thus resulting in serious jitter of the video; and in the embodiments of the present disclosure, since the period of the timestamps of the frames of videos to be played is uniform, as can be apparent from Table 1, the frames of videos to be played are surface-rendered at a uniform rate to thereby alleviate jitter of the videos being played.

It shall be noted that the process in the steps 104 to 106 is performed repeatedly, that is, the apparatus for smoothing videos determines all the time whether the Vsync event detecting thread is to be resumed, and if the Vsync event detecting thread is to be resumed, then the process will proceed to the step Step105, and further selectively to the step Step106.

The embodiment of the present disclosure provides a method for smoothing videos, the method including: receiving a first indication message, and initiating a Vsync event detecting thread in response to the first indication message, where the Vsync event detecting thread is configured, upon being resumed, to detect whether a frame of videos to be played which satisfies a predetermined condition is stored; obtaining an N-th frame of videos to be played, and storing it in a first queue created in advance, where the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played; and determining whether the Vsync event detecting thread is to be resumed, and if it is determined that the Vsync event detecting thread is to be resumed, then detecting the frame of videos to be played which satisfies the predetermined condition is stored in the first queue, according to the timestamps corresponding to the frames of videos to be played in the first queue, and if the frame of videos to be played which satisfies the predetermined condition is stored in the first queue, then rendering the frame of videos to be played which satisfies the predetermined condition. With the solution above according to the embodiment of the present disclosure, if the player starts playing, then the Vsync event detecting thread is initiated, if the Vsync event detecting thread is resumed, then a frame of videos to be played which satisfies a predetermined condition is stored in the first queue is detected according to the timestamps corresponding to the frames of videos to be played in the first queue, and if a frame of videos to be played which satisfies the predetermined condition is detected, then the frame of videos to be played is rendered; and since the periods of the timestamps corresponding to the frames of videos to be played are uniform, the frame of videos to be played which satisfies the predetermined condition can be selected with reference to the timestamp of the frame of videos to be played, and be rendered so that the frame of videos to be played can be rendered at a uniform rate, thereby alleviating jitter of the videos being played.

### Second Embodiment

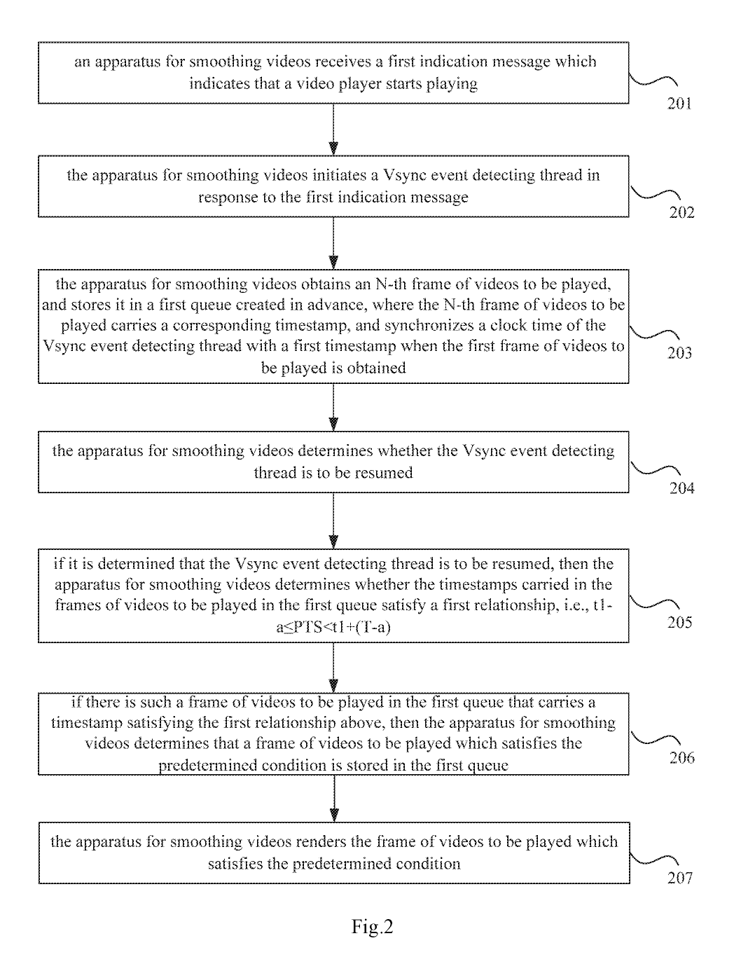

As illustrated in FIG. 2 in particular, a method for smoothing videos according to an embodiment of the present disclosure includes:

Step201, an apparatus for smoothing videos receives a first indication message which indicates that a video player starts playing.

Particularly if a user plays the videos, then the apparatus for smoothing videos will firstly receive the first indication message generated as a result of the user triggering the video player, where the first indication message indicates that the video player starts playing.

It shall be noted that the apparatus for smoothing videos in the embodiment of the present disclosure may particularly be a separate apparatus installed in an Android video playing device, or may be an apparatus integrated in the Android video playing device, and the embodiments of the present disclosure will not be limited thereto, although the apparatus for smoothing videos receives the first indication message which indicates that the video player starts playing.

Step202, the apparatus for smoothing videos initiates a Vsync event detecting thread in response to the first indication message.

Here the Vsync event detecting thread is configured, upon being resumed, to detect a frame of videos to be played which satisfies a predetermined condition is stored.

Particularly the apparatus for smoothing videos starts the Vsync event detecting thread in response to the first indication message upon reception of the first indication message.

It shall be noted that the Vsync event detecting thread is configured to detect a Vsync signal generated by the system periodically within surface render periods, and if there is no Vsync signal arriving, then the Vsync event detecting thread will be suspended; or if there is a Vsync signal arriving, then the Vsync event detecting thread will be resumed once and further detect whether appropriate data of a frame of videos to be played are stored, and if there are such data, then the data of the frame of videos will be surface-rendered.

It shall be noted that Vsync in the embodiment of the present disclosure may be synchronization of a video frame or synchronization of another frame to be rendered, so the resumed Vsync event detecting thread will detect not only synchronization information of the video frames, but also synchronization information of the other frames to be rendered. And the embodiment of the present disclosure will not be limited thereto, but the videos will be smoothed as described in the embodiment of the present disclosure, so only the synchronization information of the video frames will be described in the embodiment of the present disclosure, while the Vsync event detecting thread will not handle the other frames to be rendered in the embodiment of the present disclosure.

Stpe203, the apparatus for smoothing videos obtains an N-th frame of videos to be played, and stores it in a first queue created in advance, where the N-th frame of videos to be played carries a corresponding timestamp, and synchronizes a clock time of the Vsync event detecting thread with a first timestamp when the first frame of videos to be played is obtained.

Here N≧1 and N is an integer, and the first timestamp is a timestamp corresponding to the first frame of videos to be played.

Particularly while the videos are being played, the apparatus for smoothing videos obtains the N-th frame of videos to be played, and stores the N-th frame of videos to be played in the first queue created in advance, where the N-th frame of videos to be played carries the corresponding timestamp.

Here the clock time of the Vsync event detecting thread will be synchronized with the timestamp corresponding to the first frame of videos to be played when the first frame of videos to be played is obtained, that is, if the timestamp of the first frame of videos to be played is 25 ms, then the clock time of the Vsync event detecting threshold is synchronized to 25 ms when the first frame of videos to be played is obtained, thereby ensuring timestamps of all the frames of videos to be played which are started with the first frame of videos to be played to lie in a detection period of time of the Vsync event detecting thread.

Step204, the apparatus for smoothing videos determines whether the Vsync event detecting thread is to be resumed.

Particularly the apparatus for smoothing videos may determine whether the Vsync event detecting thread is to be resumed, as follows:

It is determined whether a Vsync signal generated periodically within surface render periods is received; and

If the Vsync signal is received, then it is determined that the Vsync event detecting thread is to be resumed.

By way of an example, the surface render frequency is typically 60 Hz, that is, the render period is 16 ms, so a Vsync signal will be generated by the system at an interval of 16 ms, and be sent to the apparatus for smoothing videos, and the apparatus for smoothing videos can determine that the Vsync event detecting thread is to be resumed, and further perform the following respective steps, upon reception of the Vsync signal; and of course, if there is no Vsync signal arriving, then the Vsync event detecting thread will be suspended, so the following respective steps will temporality not be performed.

Step205, if it is determined that the Vsync event detecting thread is to be resumed, then the apparatus for smoothing videos determines whether the timestamps carried in the frames of videos to be played in the first queue satisfy a first relationship, as follow:

t1−a≦PTS<t1+(T−a),

Where t1 represents a current clock time of the Vsync event detecting thread, a represents a predetermined clock offset, PTS represents a timestamp carried by a frame of video to be played in the first queue, and T represents the surface render period, i.e., a Vsync period.

It shall be noted that the predetermined clock offset in the embodiment of the present disclosure is a predetermined reference variable to reflect a whole offset of a timestamp of a frame of videos to be played which are to be surface-rendered, relative to a surface render time. The whole offset may be a reference variable less than T, or may be a reference variable no less than T, and the embodiment of the present disclosure will not be limited thereto.

Preferably the predetermined clock offset in the first relationship satisfies a second condition, which may be 0≦a<T.

It shall be noted that in order to ensure that the frame of videos to be played is rendered at a time closer to the timestamp thereof, the predetermined clock offset in the first relationship is defined as less than the surface render period, so that jitter of the videos can be further alleviated.

Preferably the value of a is ½T, so the first relationship is t1−½T≦PTS<t1+½T, and at this time, the frame of videos to be played can be ensured to be rendered at the closest time to the timestamp thereof, so that jitter of the videos can be still further alleviated.

Step206, if there is such a frame of videos to be played in the first queue that carries a timestamp satisfying the first relationship above, then the apparatus for smoothing videos determines that a frame of videos to be played which satisfies the predetermined condition is stored in the first queue.

It shall be noted that since the periods of the timestamps of the frames of videos to be played are typically more than the surface render period, whether a frame of video to be played which satisfies the predetermined condition is stored in the first queue is detected with reference to the timestamps of the frames of videos to be played, then such an instance will not occur that there are two frames of videos to be played which both satisfy the predetermined condition, so such an instance in the prior art will not occur that with reference to the acquisition time of the frame of videos to be played. And if there is an error of at least ±10 ms between the acquisition time and the timestamps of the frames of videos, then more than one frame of videos will be stored in a display buffer for subsequent surface rendering, but only one of the frames can be rendered, and the other frames of videos will be discarded, thereby alleviating jitter of the videos.

Step207, the apparatus for smoothing videos renders the frame of videos to be played which satisfies the predetermined condition.

Particularly if a frame of videos to be played which satisfies the predetermined condition is stored in the first queue, then the apparatus for smoothing videos will render the frame of videos to be played which satisfies the predetermined condition.

Reference can be made to the related description of Table 1 in the first embodiment for details about an example in which the apparatus for smoothing videos renders the frame of videos to be played which satisfies the predetermined condition, so a repeated description thereof will be omitted here in the embodiment of the present disclosure.

It shall be noted that if no frame of videos to be played which satisfies the predetermined condition is stored in the first queue, then at this time the apparatus for smoothing videos will not render any frame of videos, as depicted by a sign “ - - - ” in Table 1.

It shall be noted that the process in the steps 204 to 207 is performed repeatedly, that is, the apparatus for smoothing videos determines all the time whether the Vsync event detecting thread is to be resumed, and if the Vsync event detecting thread is to be resumed, then the process will proceed to the step205, and further selectively to the step206 and the step207.

The embodiment of the present disclosure provides a method for smoothing videos, the method including: receiving a first indication message, and initiating a Vsync event detecting thread in response to the first indication message, where the Vsync event detecting thread is configured, upon being resumed, to detect whether a frame of videos to be played, which satisfies a predetermined condition is stored; obtaining an N-th frame of videos to be played, and storing it in a first queue created in advance, where the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played; and determining whether the Vsync event detecting thread is to be resumed, and if it is determined that the Vsync event detecting thread is to be resumed, then detecting the frame of videos to be played which satisfies the predetermined condition is stored in the first queue, according to the timestamps corresponding to the frames of videos to be played in the first queue, and if the frame of videos to be played which satisfies the predetermined condition is stored in the first queue, then rendering the frame of videos to be played which satisfies the predetermined condition. With the solution above according to the embodiment of the present disclosure, if the player starts playing, then the Vsync event detecting thread is initiated, if the Vsync event detecting thread is resumed, then a frame of videos to be played which satisfies a predetermined condition is stored in the first queue is detected according to the timestamps corresponding to the frames of videos to be played in the first queue, and if a frame of videos to be played which satisfies the predetermined condition is detected, then the frame of videos to be played is rendered; and since the periods of the timestamps corresponding to the frames of videos to be played are uniform, the frame of videos to be played which satisfies the predetermined condition can be selected with reference to the timestamp of the frame of videos to be played, and be rendered so that the frame of videos to be played can be rendered at a uniform rate, thereby alleviating jitter of the videos being played.

### Third Embodiment

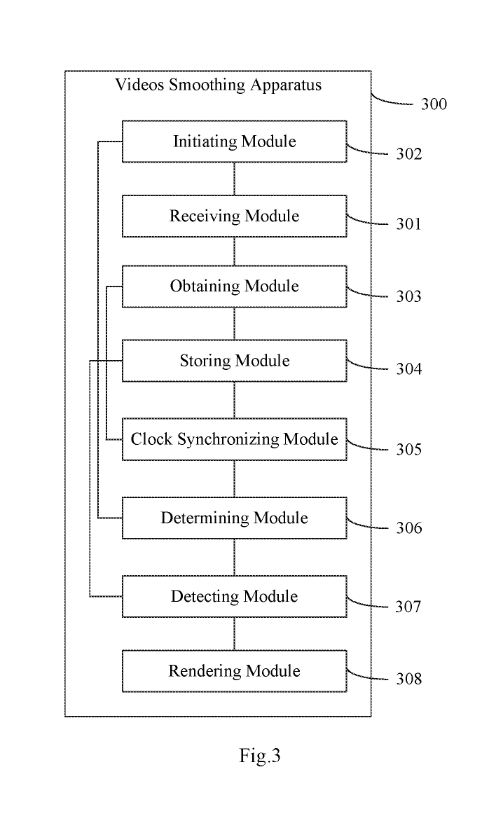

An embodiment of the present disclosure provides an apparatus 300 for smoothing videos, and as particularly illustrated in FIG. 3, the apparatus 300 may include: a receiving module 301, an initiating module 302, an obtaining module 303, a storing module 304, a clock synchronizing module 305, a determining module 306, a detecting module 307, and a rendering module 308.

The receiving module 301 is configured to receive a first indication message which indicates that a video player starts playing.

The initiating module 302 is configured to initiate a Vsync event detecting thread in response to the first indication message received by the receiving module 301, where the event detecting thread is configured, upon being resumed, to detect whether a frame of videos to be played which satisfies a predetermined condition is stored.

The obtaining module 303 is configured to obtain an N-th frame of videos to be played.

The storing module 304 is configured to store the N-th frame of videos to be played which is obtained by the obtaining module 303 in a first queue created in advance, where the N-th frame of videos to be played carries a corresponding timestamp.

The clock synchronizing module 305 is configured to synchronize a clock time of the Vsync event detecting thread with a first timestamp when the obtaining module 303 obtains the first frame of videos to be played, where N≧1 and N is an integer, and the first timestamp is a timestamp corresponding to the first frame of videos to be played.

The determining module 306 is configured to determine whether the Vsync event detecting thread is to be resumed.

The detecting module 307 is configured, if the determining module 306 determines that the Vsync event detecting thread is to be resumed, to detect whether the frame of videos to be played which satisfies the predetermined condition is stored in the first queue, according to the timestamps corresponding to the frames of videos to be played which are stored by the storing module 304 in the first queue.

The rendering module 308 is configured, if the detecting module 307 detects the frame of videos to be played which satisfies the predetermined condition is stored by the storing module 304 in the first queue, to render the frame of videos to be played which satisfies the predetermined condition.

Furthermore the determining module 306 may be specifically configured:

To determine whether a Vsync signal generated periodically within surface render periods is received; and

If the Vsync signal is received, to determine that the Vsync event detecting thread is to be resumed.

In an embodiment of the present disclosure, the predetermined condition may specifically include:

A condition that the timestamps carried in the frames of videos to be played satisfy a first relationship, where the first relationship is as follow:

t1−a≦PTS<t1+(T−a),

Where t1 represents a current clock time of the Vsync event detecting thread, a represents a predetermined clock offset, PTS represents a timestamp carried by a frame of videos to be played, and T represents the surface render period.

Preferably the predetermined clock offset in the first relationship satisfies a second condition that:

0≦a<T.

Specifically the predetermined clock offset may include:

a=½T, where the first relationship is as follow:

t1−½T≦PTS<t1+½T.

Reference can be made to the descriptions in the first embodiment and the second embodiment for details about the process of smoothing the video by the apparatus 300 for smoothing videos, so a repeated description thereof will be omitted here.

### Fourth Embodiment

An embodiment of the present disclosure further provides a computer readable recording medium on which programs for performing any one of the methods according to the above embodiments of the present disclosure are recorded.

The computer readable recording medium includes any mechanism for storing or transporting computer (for example, a PC) readable information. For example the machine readable medium includes a Read Only Memory (ROM), a Random Access Memory (RAM), a magnetic disk storage medium, an optical storage medium, a flash memory medium, an electric, optical, acoustic or another form of propagated signal (e.g., a carrier wave, an infrared signal, a digital signal, etc.), etc.

The embodiment of the present disclosure provides an apparatus for smoothing videos, where if a receiving module receives a first indication message, then an initiating module initiates a Vsync event detecting thread, if a determining module determines that the Vsync event detecting thread is to be resumed, then a detecting module detects a frame of videos to be played which satisfies a predetermined condition is stored in a first queue according to timestamps of frames of videos to be played in the first queue, and if the detecting module detects the frame of videos to be played which satisfies the predetermined condition is stored, then the rendering module renders the frame of videos to be played; and since the period of the timestamps corresponding to the frames of videos to be played are uniform, the frame of videos to be played which satisfies the predetermined condition can be selected with reference to the timestamps of the frames of videos to be played, and be rendered so that the frames of videos to be played can be rendered at a uniform rate, thereby alleviating jitter of the videos being played.

Those skilled in the art can readily appreciate that the respective functional modules have been exemplified above for the sake of convenience and conciseness, but in a practical application, the functions above can be allocated to different functional modules as needed, that is, the internal structure of the apparatus can be divided into different functional modules for performing all or a part of the functions described above. Reference can be made to the corresponding processes in the embodiments of the method described above for particular operational processes of the apparatus described above, so a repeated description thereof will be omitted here.

In the several embodiments of the present disclosure, it shall be appreciated that the disclosed apparatus and method can be embodied otherwise. For example the embodiments of the apparatus described above are merely illustrative. Furthermore the illustrated or described coupling or direct coupling between the modules can be established via some interface, and indirect coupling or communication connection between the modules can be electrical, mechanical or in another form.

The modules described as separate components may or may not be physically separate, and the components illustrated as modules may be one or more physical modules, that is, they can be collocated or can be distributed at a number of places. A part or all of the modules can be selected as needed in reality for the purpose of the solution according to the embodiments of the present disclosure.

Moreover the respective functional modules in the respective embodiments of the present disclosure can be integrated in a processing module, or the respective modules can be physically embodied separately, or two or more of the modules can be integrated in a module. The integrated modules can be embodied in the form of hardware or can be embodied in the form of software functional modules.

If the integrated modules are embodied in the form of software functional modules, and sold or used as a separate product, then they can be stored in a readable storage medium. Based upon such understanding, the technical solutions of the present disclosure essentially or their parts contributing to the prior art or all or a part of the technical solutions can be embodied in the form of a software product stored in a storage medium, which includes several instructions to cause a device (e.g., a monolithic processor, a chip, etc.) or a processor to perform all or a part of the steps in the method according to the respective embodiments of the present disclosure. The storage medium includes a U-disk, a mobile hard disk, a Read-Only Memory (ROM), a Random Access Memory (RAM), a magnetic disk, an optic disk, and any other medium in which program codes can be stored.

The foregoing disclosure is illustrative of the particular embodiments of the present disclosure, but the present disclosure shall not be limited thereto; and any variations or equivalents which can readily occur to those skilled in the art without departing from the scope of the disclosure of the present disclosure shall fall into the scope of the present disclosure. Accordingly the scope of the present disclosure shall be as defined in the appended claims.

1-11. (canceled)

12. A method for smoothing videos, the method comprising:
receiving a first indication message which indicates that a video player starts playing;
initiating a frame synchronization (Vertical Synchronization (Vsync)) event detecting thread in response to the first indication message, wherein the Vsync event detecting thread is configured, upon being resumed, to detect whether a frame of videos to be played which satisfies a predetermined condition is stored;
obtaining an N-th frame of videos to be played, and storing it in a first queue created in advance, wherein the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played;
determining whether the Vsync event detecting thread is to be resumed;
detecting, if it is determined that the Vsync event detecting thread is to be resumed, whether the frame of videos to be played which satisfies the predetermined condition is stored in the first queue, according to the timestamps corresponding to the frames of videos to be played in the first queue; and
rendering, if there is the frame of videos to be played which satisfies the predetermined condition is stored in the first queue, the frame of videos to be played which satisfies the predetermined condition.

13. The method according to claim 12, wherein the determining whether the Vsync event detecting thread is to be resumed comprises:
determining whether a Vsync signal generated periodically within surface render periods is received; and
determining, if the Vsync signal is received, that the Vsync event detecting thread is to be resumed.

14. The method according to claim 12, wherein the predetermined condition comprises:
a condition that the timestamps carried in the frames of videos to be played satisfy a first relationship, wherein the first relationship is as follow:
t1−a≦PTS<t1+(T−a),
where t1 represents a current clock time of the Vsync event detecting thread, a represents a predetermined clock offset, PTS represents a timestamp carried by a frame of videos to be played, and T represents the surface render period.

15. The method according to claim 13, wherein the predetermined condition comprises:
a condition that the timestamps carried in the frames of videos to be played satisfy a first relationship, wherein the first relationship is as follow:
t1−a≦PTS<t1+(T−a),
where t1 represents a current clock time of the Vsync event detecting thread, a represents a predetermined clock offset, PTS represents a timestamp carried by a frame of videos to be played, and T represents the surface render period.

16. The method according to claim 14, wherein the predetermined clock offset in the first relationship satisfies a second condition, wherein the second condition is as follow:
0≦a<T.

17. The method according to claim 15, wherein the predetermined clock offset in the first relationship satisfies a second condition, wherein the second condition is as follow:
0≦a<T.

18. The method according to claim 16, wherein the predetermined clock offset comprises:
a=½T,
wherein the first relationship is as follow:
t1−½T≦PTS<t1+½T.

19. The method according to claim 17, wherein the predetermined clock offset comprises:
a=½T,
wherein the first relationship is as follow:
t1−½T≦PTS<t1+½T.

20. An apparatus for smoothing videos, the apparatus comprising:
one or more processors; and
a memory;
wherein one or more programs are stored in the memory, and when executed by the one or more processors, the one or more programs cause the one or more processors to:
receive a first indication message which indicates that a video player starts playing;
initiate a frame synchronization (Vertical Synchronization (Vsync)) event detecting thread in response to the first indication message, wherein the Vsync event detecting thread is configured, upon being resumed, to detect whether a frame of videos to be played which satisfies a predetermined condition is stored;
obtain an N-th frame of videos to be played, and storing it in a first queue created in advance, wherein the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played;
determine whether the Vsync event detecting thread is to be resumed;
detect, if it is determined that the Vsync event detecting thread is to be resumed, whether the frame of videos to be played which satisfies the predetermined condition is stored in the first queue, according to the timestamps corresponding to the frames of videos to be played in the first queue; and
render, if there is the frame of videos to be played which satisfies the predetermined condition is stored in the first queue, the frame of videos to be played which satisfies the predetermined condition.

21. The apparatus according to claim 20, wherein the one or more processors are configured to:
determine whether a Vsync signal generated periodically within surface render periods is received; and
determine, if the Vsync signal is received, that the Vsync event detecting thread is to be resumed.

22. The apparatus according to claim 20, wherein the predetermined condition comprises:
a condition that the timestamps carried in the frames of videos to be played satisfy a first relationship, wherein the first relationship is as follow:
t1−a≦PTS<t1+(T−a),
where t1 represents a current clock time of the Vsync event detecting thread, a represents a predetermined clock offset, PTS represents a timestamp carried by a frame of videos to be played, and T represents the surface render period.

23. The apparatus according to claim 21, wherein the predetermined condition comprises:
a condition that the timestamps carried in the frames of videos to be played satisfy a first relationship, wherein the first relationship is as follow:
t1−a≦PTS<t1+(T−a),
where t1 represents a current clock time of the Vsync event detecting thread, a represents a predetermined clock offset, PTS represents a timestamp carried by a frame of videos to be played, and T represents the surface render period.

24. The apparatus according to claim 22, wherein the predetermined clock offset in the first relationship satisfies a second condition, wherein the second condition is as follow:
0≦a<T.

25. The apparatus according to claim 23, wherein the predetermined clock offset in the first relationship satisfies a second condition, wherein the second condition is as follow:
0≦a<T.

26. The apparatus according to claim 24, wherein the predetermined clock offset comprises:
a=½T,
wherein the first relationship is as follow:
t1−½T≦PTS<t1+½T.

27. The apparatus according to claim 25, wherein the predetermined clock offset comprises:
a=½T,
wherein the first relationship is as follow:
t1−½T≦PTS<t1+½T.

28. A computer readable recording medium, on which programs for performing a method for smoothing videos are recorded, wherein the method comprising:
receiving a first indication message which indicates that a video player starts playing;
initiating a frame synchronization (Vertical Synchronization (Vsync)) event detecting thread in response to the first indication message, wherein the Vsync event detecting thread is configured, upon being resumed, to detect whether a frame of videos to be played which satisfies a predetermined condition is stored;
obtaining an N-th frame of videos to be played, and storing it in a first queue created in advance, wherein the N-th frame of videos to be played carries a corresponding timestamp, and synchronizing a clock time of the Vsync event detecting thread with a first timestamp when the first frame of videos to be played is obtained, where N≧1 and N is an integer, and the first timestamp is a timestamp corresponding to the first frame of videos to be played;
determining whether the Vsync event detecting thread is to be resumed;
detecting, if it is determined that the Vsync event detecting thread is to be resumed, whether the frame of videos to be played which satisfies the predetermined condition is stored in the first queue, according to the timestamps corresponding to the frames of videos to be played in the first queue; and
rendering, if there is the frame of videos to be played which satisfies the predetermined condition is stored in the first queue, the frame of videos to be played which satisfies the predetermined condition.
